(19) United States
(12) Patent Application Publication
(10) Pub. No.: US 2026/0153262 A1
(43) Pub. Date: Jun. 4, 2026

(54) Raceway and Raceway System for Heating, Ventilation, and Air Conditioning System

(71) Applicant: IBACOS, Inc., Pittsburgh, PA (US)

(72) Inventors: Andrew Poerschke, Pittsburgh, PA (US); Brian Wolfgang, Irwin, PA (US); Bruce Dickson, West Mifflin, PA (US)

(21) Appl. No.: 19/298,530

(22) Filed: Aug. 13, 2025

Related U.S. Application Data
(60) Provisional application No. 63/706,878, filed on Oct. 14, 2024.

(51) Int. Cl. F24F 13/02; H02G 3/04

(52) U.S. Cl. CPC F24F 13/0254; H02G 3/0456

(57) ABSTRACT

A raceway system, including at least two hanger frames configured to support at least one component, the at least two hanger frames including, at least two hanger brackets elements, the at least two hanger brackets including, at least one outer bracket element, at least one inner bracket element, and at least one position locking mechanism for mechanically securing the hanger brackets elements in a position, wherein the inner bracket element is configured to nest within the outer bracket element and the bracket elements are connected by the at least one position locking mechanism at a predetermined distance. A method of installing the raceway system in a target space.

### CROSS REFERENCE TO RELATED APPLICATION

This application claims priority to U.S. Provisional Patent Application No. 63/706,878, filed Oct. 14, 2024, the disclosure of which is incorporated by reference herein in its entirety.

### STATEMENT REGARDING FEDERALLY SPONSORED RESEARCH

This invention was made with government support under Grant No. DE-AC36-08GO28308 awarded by the United States Department of Energy, Office of Science. The government has certain rights in the invention.

### BACKGROUND OF THE INVENTION

### Field of the Invention

The present disclosure is generally directed to a raceway system designed to be prefabricated and installed in buildings to provide a plenum volume to route HVAC ductwork and other mechanical, electrical, or plumbing components.

When a home is fitted for HVAC systems, a common problem is the installation of raceways, soffits and chases, to house the ductwork and other mechanical, electrical, or plumbing components. Installation of the raceways is difficult and often requires custom one-off designs to fit to an individual space. These custom installations can be costly and prohibitive for individuals trying to install a new HVAC system.

Further, these raceways and the parts they house are not aesthetically pleasing and can become hazards if left uncovered. The present disclosure provides examples of systems and methods of use for a prefabricated raceway system that is adjustable to fit into a multitude of different houses with cover panels reducing the hazard risk.

### SUMMARY OF THE INVENTION

In light of the foregoing, there is a need for a prefabricated, adjustable raceway system that can be easily installed in a variety of building configurations to house HVAC ductwork and other mechanical, electrical, or plumbing components, while providing an aesthetically pleasing appearance and reducing associated safety hazards.

Further non-limiting embodiments or aspects will be set forth in the following numbered clauses:

Clause 1: A raceway system, comprising: at least two hanger frames configured to support at least one component, the at least two hanger frames comprising at least two hanger bracket elements, the at least two hanger brackets elements including at least one outer bracket element and at least one inner bracket element, and at least one position locking mechanism for mechanically securing the at least two hanger bracket elements in a position, and wherein the at least one inner bracket element is configured to nest within the at least one outer bracket element and the two hanger bracket elements are connected by the position locking mechanism at a predetermined distance.

Clause 2: The raceway system of clause 1, wherein the at least two hanger frames is four hanger brackets elements.

Clause 3: The raceway system of any of clauses 1 or 2, wherein the at least one position locking mechanism comprises: multiple bendable tabs on the outer bracket element, and a notch on the inner bracket element, and wherein a bendable tab of the outer bracket element is bent such that it is fit into the notch of the inner bracket element.

Clause 4: The raceway system of any of clauses 1-3, wherein the at least one position locking mechanism comprises: multiple detents on the inner bracket element, and a groove on the outer bracket element, and wherein a detent of inner bracket element is fixedly connected with the groove of the outer bracket element.

Clause 5: The raceway system of any of clauses 1-4, wherein the at least one position locking mechanism comprises: a bendable table on the outer bracket element, and wherein the bendable tab is bent inward such that it presses against the nested inner bracket element creating a friction fit.

Clause 6: The raceway system of any of clauses 1-5, wherein the at least one position locking mechanism comprises: a screw pilot hole on the outer bracket element, and a screw, wherein the screw is inserted in the screw pilot hole such that it presses against the nested inner bracket element creating a mechanical or friction fit.

Clause 7: The raceway system of any of clauses 1-6, wherein the at least one position locking mechanism comprises: at least one hem on the outer bracket element, wherein when nested, the hem wraps around the inner bracket element locking the bracket elements in a position; and a screw, wherein the screw is inserted in a screw pilot hole on the outer bracket element such that it presses against the nested inner bracket element creating a friction fit.

Clause 8: The raceway system of any of clauses 1-7, wherein each of the at least one outer bracket elements include a horizontal arm and a vertical arm, and each of the at least one inner bracket elements include a horizontal arm and a vertical arm, wherein the horizontal arm of one of the at least one outer bracket elements is configured to receive the horizontal arm of one of the at least one inner bracket elements, and the vertical arm of one of the at least one outer bracket elements is configured to receive the vertical arm of one of the at least one inner bracket elements.

Clause 9: The raceway system of any of clauses 1-8, wherein the vertical arm of at least one outer bracket element includes a plurality of slots, and the vertical arm of at least one inner bracket element includes a plurality of holes, wherein at least one of the plurality of holes is positioned to align with at least one of the plurality of slots when the vertical arm of the inner bracket element is nested within the vertical arm of the outer bracket element, and wherein a screw is configured to extend through the aligned hole and slot from the inner bracket element toward the outer bracket element to secure the hanger frame to a surface.

Clause 10: The raceway system of any of clauses 1-9, wherein the horizontal arm of at least one outer bracket element includes a plurality of slots, and the horizontal arm of at least one inner bracket element includes a plurality of holes, wherein at least one of the plurality of holes is positioned to align with at least one of the plurality of slots when the horizontal arm of the inner bracket element is nested within the horizontal arm of the outer bracket element, and wherein a screw is configured to extend through the aligned hole and slot from the inner bracket element toward the outer bracket element to secure the hanger frame to a surface.

Clause 11: The raceway system of any of clauses 1-10, wherein the horizontal arm of at least one inner bracket elements includes the plurality of slots at an end opposite the plurality of holes, wherein the screw is configured to extend through at least one of the slots to secure the hanger frame to a surface.

Clause 12: The raceway system of any of clauses 1-11, further comprising: at least two panels configured to enclose a volume defined by the at least two hanger frames, wherein the at least two panels are connected to the at least two hanger frames by a panel attachment mechanism.

Clause 13: The raceway system of any of clauses 1-12, further comprising: at least one trim element configured to cover an edge of the at least two panels.

Clause 14: The raceway system of any of clauses 1-13, wherein the panel attachment mechanism includes a rod suspended within the at least two hanger frames, and a complementary clip fastened to a panel, wherein the complementary clip is mechanically fixed to the rod.

Clause 15: The raceway system of clauses 1-14, wherein the panel attachment mechanism includes a hole in a bracket element, and a pyramid shaped clip fixed to a panel, wherein the pyramid shaped clip is inserted in the hole in the bracket element such that the pyramid shaped clip is self-guided and non-releasably mated with the hole in the bracket element.

Clause 16: The raceway system of any of clauses 1-15, wherein the panel attachment mechanism includes a slot in a hanger bracket element, and a triangle shaped clip fixed to a panel, wherein the triangle shaped clip is inserted in the slot in the bracket element such that the triangle shaped clip is non-releasably mated with the hole in the bracket element while allowing for translation across one axis.

Clause 17: The raceway system of any of clauses 1-16, wherein the triangle shaped clip is fixed to the panel via a translation mechanism, wherein the triangle shaped clip comprises: a triangular body, and a base, and wherein the translation mechanism is a compressed ‘c’ shaped bracket attached to the panel configured to receive the base of the triangle shaped clip allowing for translation across an additional axis.

Clause 18: The raceway system of any of clauses 1-17 wherein, at least one panel has an opening for a ductwork boot.

Clause 19: A method of using reality capture to design and prefab a layout for the raceway system of clause 1 comprising: capturing a digital scan of a target building in which the raceway system is to be installed, converting the scan to a simplified 3D geometry, determining viable areas of the target building to locate a mechanical soffit, determining an optimal HVAC design, generating ductwork layout based on the viable areas, creating a set of fabrication instructions and shop drawings based on the optimal HVAC design, prefabricating panels based on the fabrication instructions and the shop drawings, assembling at least two hanger bracket elements to create at least two hanger frames of the desired dimension, and connecting the raceway system in the target building.

Clause 20: The method of clause 19 wherein, connecting the raceway system in the target building comprises: installing the at least two hanger frames in the target building, fitting components through the at least two hanger frames, attaching at least one panel to the at least two hanger frames, and joining at least one trim to each panel.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a section view of an assembled raceway system constructed in accordance with the principles of the present invention;

FIG. 2 is a perspective view of an assembled raceway system housing ductwork constructed in accordance with the principles of the present invention;

FIG. 3 is a perspective view of an example of an adjustable hanger frame constructed in accordance with the principles of the present invention;

FIG. 4A is an outer hanger bracket element in a preassembled state in accordance with the principles of the present invention;

FIG. 4B is an inner hanger bracket element in a preassembled state in accordance with the principles of the present invention;

FIG. 5 is a perspective view of an assembled hanger frame adjustable in the Z and Y axes constructed in accordance with the principles of the present invention;

FIG. 6 is a perspective view of an assembled hanger frame adjustable in the Z and Y axes constructed in accordance with the principles of the present invention;

FIG. 7A is a perspective view of an example of an adjustable hanger frame with a multiple bendable tabs position locking mechanism constructed in accordance with the principles of the present invention;

FIG. 7B is a perspective view of an example of an adjustable hanger frame with a multiple detents position locking mechanism constructed in accordance with the principles of the present invention;

FIG. 8A is a perspective view of an embodiment of a panel attachment mechanism constructed in accordance with the principles of the present invention;

FIG. 8B is a perspective view of an embodiment of a panel attachment mechanism with a panel attached constructed in accordance with the principles of the present invention;

FIG. 9 is a perspective view of an embodiment of a panel attachment mechanism with a panel attached constructed in accordance with the principles of the present invention;

FIG. 10A is a perspective view of an embodiment of a panel attachment mechanism allowing for translation in the X axis with a panel attached constructed in accordance with the principles of the present invention;

FIG. 10B is a perspective view of an embodiment of a panel attachment mechanism allowing for translation in the X and Y axes with a panel attached constructed in accordance with the principles of the present invention;

FIG. 11 is an illustrative example of a flow chart for a method of prefabricating soffit system based on reality capture data; and

FIGS. 12A and 12B are illustrative depictions of a method of converting reality capture data into fabrication instructions.

### DESCRIPTION OF THE INVENTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the concept as it is oriented in the drawing figures. However, it is to be understood that the concept may assume various alternative variations, except where expressly specified to the contrary. It is also to be understood that the specific devices illustrated in the attached drawings, and described in the following specification, are simply exemplary embodiments of the concept. Hence, specific dimensions and other physical characteristics related to the embodiments disclosed herein are not to be considered as limiting.

The word “comprising” and “comprises”, and the like, does not exclude the presence of elements or steps other than those listed in any claim or the specification as a whole. In the present specification, “comprises” means “includes” and “comprising” means “including.”

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “at least” is synonymous with “greater than or equal to”. The terms “first”, “second”, and the like are not intended to refer to any particular order or chronology, but refer to different conditions, properties, or elements. As used herein, the singular form of “a”, “an”, and “the” include plural referents unless the context clearly dictates otherwise.

All numbers used in the specification and claims are to be understood as being modified in all instances by the term “about”. By “about” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

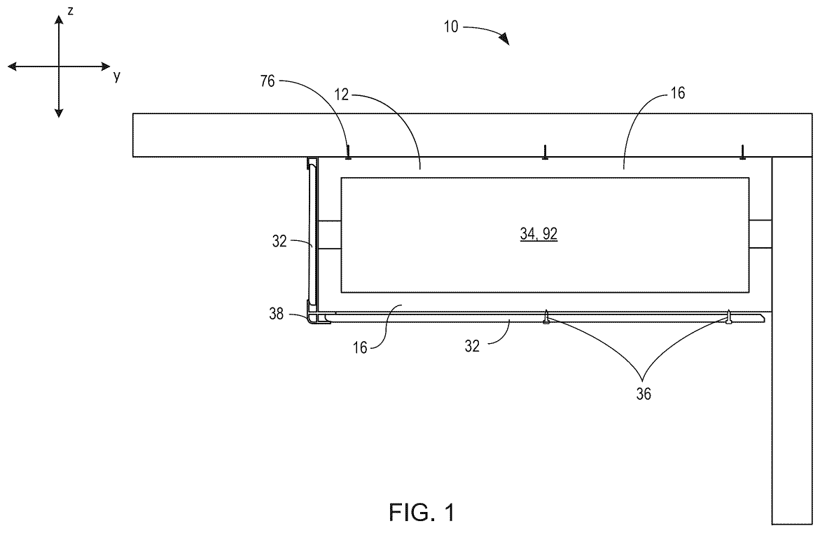

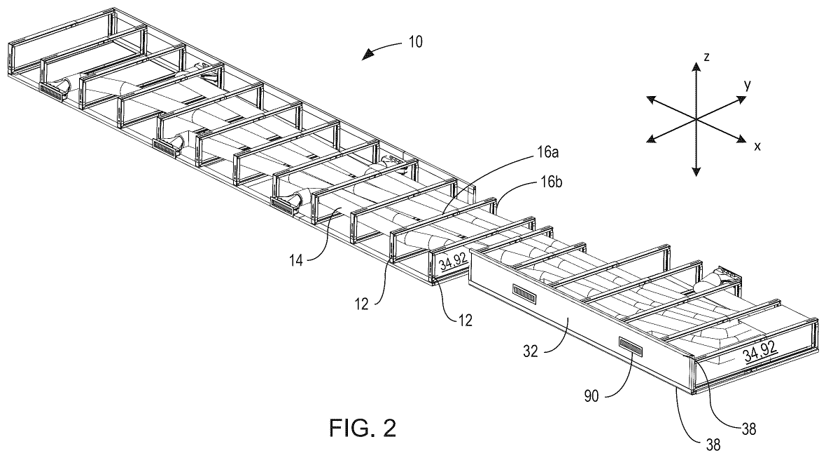

Referring to FIGS. 1-2, a raceway system 10 is shown. The raceway system 10 includes at least two hanger frames 12 configured to support at least one component 14. Each hanger frame 12 includes one or more bracket elements 16, which may comprise one or more outer bracket elements 16a and one or more inner bracket elements 16b. The inner bracket elements 16b are configured to nest within corresponding outer bracket elements 16a. The inner and outer bracket elements 16a, 16b may include at least one position locking mechanism 22 for mechanically securing the bracket elements in a desired position. For example, when an inner bracket element 16b is received by a corresponding outer bracket element 16a, the two may be locked in a coupled state by the position locking mechanism 22.

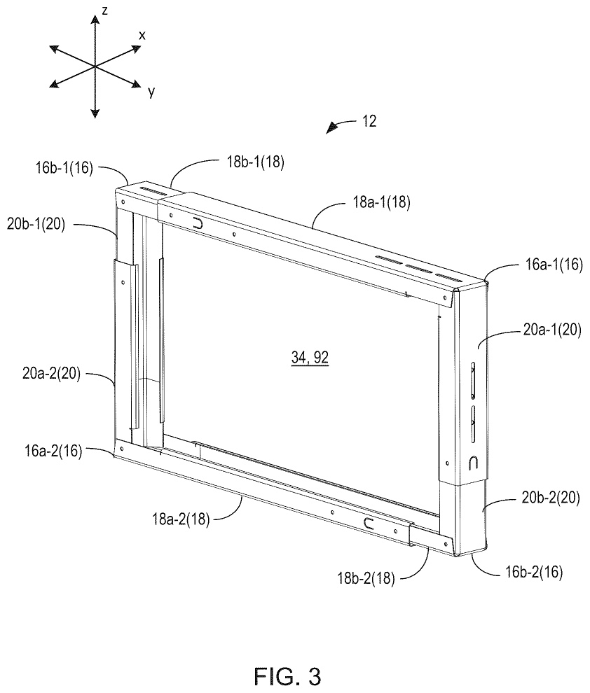

Referring now to FIG. 3, in certain embodiments, the hanger frame 12 may include four bracket elements 16. For example, two inner bracket elements 16b-1, 16b-2 and two outer bracket elements 16a-1, 16a-2. Each bracket element 16 is generally L-shaped, having a horizontal arm 18 and a vertical arm 20. In the configuration with four bracket elements 16, a horizontal arm 18b-1 of a first inner bracket element 16b-1 may be received by the horizontal arm 18a-1 of a first outer bracket element 16a-1. The vertical arm 20a-1 of the first outer bracket element 16a-1 may then receive the vertical arm 20b-2 of a second inner bracket element 16b-2. The horizontal arm 18b-2 of the second inner bracket element 16b-2 may be received by the horizontal arm 18a-2 of a second outer bracket element 16a-2, whose vertical arm 20a-2 may, in turn, receive the vertical arm 20b-1 of the first inner bracket element 16b-1. As shown in FIG. 3, the nesting of the four bracket elements 16 defines the rectangular-shaped hanger frame 12 defining an area 92.

A user may adjust the degree to which each inner bracket element 16b is received by a corresponding outer bracket element 16a to achieve the desired dimensions of the hanger frame 12. The bracket elements 16 may be adjusted in the Y and/or Z directions by sliding them to the desired width and height before engaging the at least one position locking mechanism 22 or driving a screw 28 through pilot holes 26 and/or 30, as described herein below. Adjusting the width and height of the bracket elements 16 may increase or decrease the area 92 defined by the hanger frame 12. This adjustability allows for easy installation and customization of the raceway system to fit a target building based on the components 14 that need to be housed within the hanger frames 12 and the spatial limitations of the target building. The components 14 can be, but are not limited to HVAC ductwork, or other mechanical, electrical, or plumbing elements.

In certain embodiments, the hanger frame 12 may include two hanger bracket elements 16. For example, one outer bracket element 16a and one inner bracket element 16b. In such a configuration, the bracket elements 16 are generally U-shaped, with the vertical arms 20b of the inner bracket element 16b received within the corresponding vertical arms 20a of the outer bracket element 16a. The two-bracket-element hanger frame may be adjusted in the Z-direction by sliding the bracket elements to the desired height and then engaging the at least one position locking mechanism 22. Adjusting the height of the bracket elements 16 may increase or decrease the area 92 defined by the hanger frame 12.

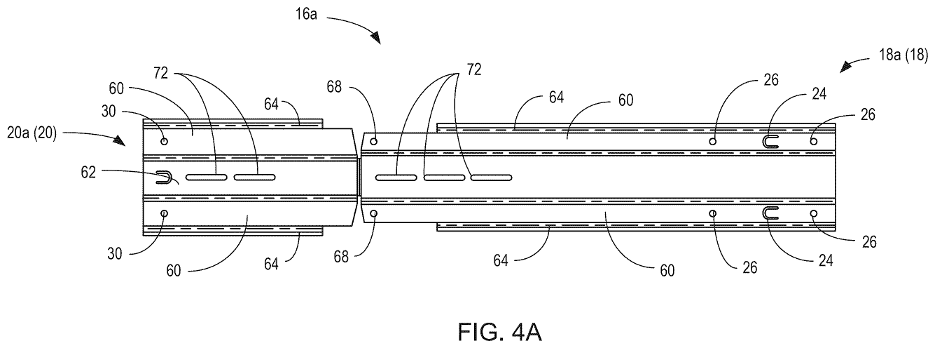

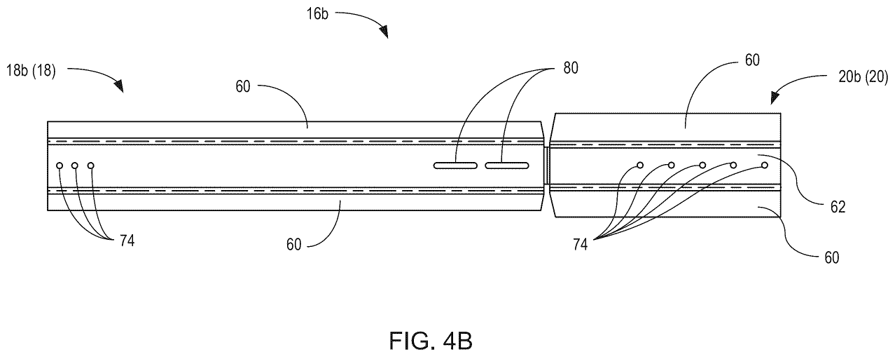

Referring now to FIGS. 4A-4B, the hanger bracket elements 16 are formed from a flat strip of metal. FIG. 4A illustrates an outer bracket element 16a, and FIG. 4B illustrates an inner bracket element 16b. The walls 60 are folded inward to form a U-shaped channel, and the flaps 62 are folded in to complete the generally L-shaped hanger bracket elements 16 with a horizontal arm 18 and a vertical arm 20, however, a user may fold the flaps 62 to any desired angle between the horizontal arm 18 and the vertical arm 20. The U-shaped channels facilitate nesting of the bracket elements 16, such that the U-shaped channel of the inner bracket element 16b may be received within the U-shaped channel of the outer bracket element 16a.

Referring to FIG. 4A, an outer bracket element 16a is shown. The horizontal arm 18a of the outer bracket element 16a preferably has a length of at least 16.461 inches. After the walls 60 are folded inward to form a U-shaped channel, the horizontal arm 18a preferably has a width of at least 1.663 inches. The vertical arm 20a of the outer bracket element 16a preferably has a length of at least 4 inches. After the walls 60 are folded inward to form a U-shaped channel, the vertical arm 20a preferably has a width of at least 1.483 inches. The dimensions provided herein are merely exemplary, and any suitable dimensions may be used such that the raceway system 10 is structurally sound. In general, the outer bracket element 16a is dimensioned larger than the inner bracket element 16b to allow the inner bracket element 16b to nest within the outer bracket element 16a.

Referring to FIG. 4B, an inner bracket element 16b is shown. The horizontal arm 18b of the inner bracket element 16b preferably has a length of at least 15.961 inches. After the walls 60 are folded inward to form a U-shaped channel, the horizontal arm preferably has a width of at least 1.553 inches. The vertical arm of the inner bracket element 16b preferably has a length of at least 7.461 inches. After the walls 60 are folded inward to form a U-shaped channel, the vertical arm preferably has a width of at least 1.373 inches.

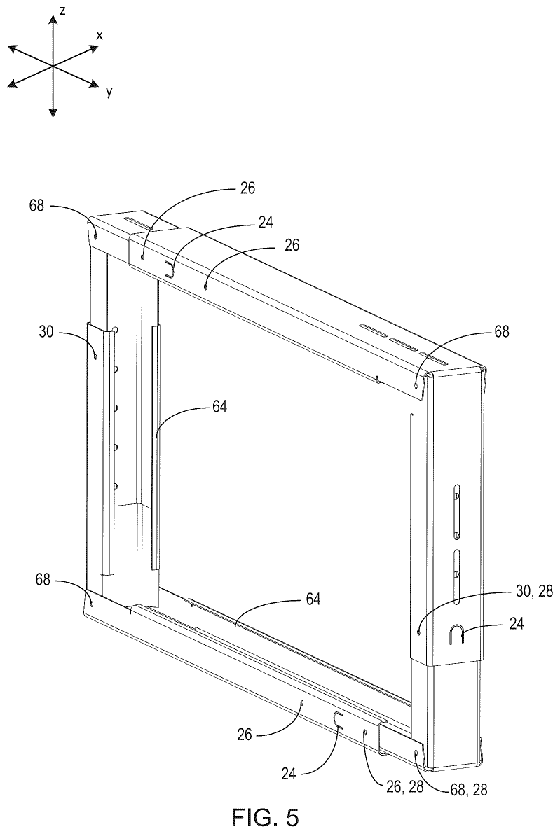

Referring to FIG. 5, in certain embodiments, the at least one position locking mechanism 22 may include a bendable retention tab 24 and horizontal pilot holes 26 on the horizontal arm 18a of the outer bracket element 16a. As shown in FIG. 4A, the bendable retention tab 24 and the horizontal pilot holes 26 may be located on the walls 60 of horizontal arm 18a of the outer bracket element 16a. The bendable retention tab 24 is configured to bend inwards at an angle to provide holding power between the outer bracket element 16a and the inner bracket element 16b and allows for finer adjustment of the width of the bracket elements 16. The horizontal pilot holes 26 allow for easier fastening when securing the hanger's width. The horizontal pilot holes 26 may be located on either side of the bendable retention tab 24 to allow for two fastening locations in narrower configurations. The horizontal pilot holes 26 allow for a screw 28 (e.g. self-tapping screws, pointed sheet metal screws, and/or the like) to be inserted to fasten the horizontal arm 18a of the outer bracket element 16a to the horizontal arm 18b of the inner bracket element 16b, thus, securing the width of the hanger frame 12. The screw 28 can be inserted in the horizontal pilot holes 26, such that it presses against the nested inner bracket element 16b creating a friction fit. Because there is no matching part on the inner bracket element 16b, the bracket elements 16 can be fit in any dimension. Because the screw 28 can be pressed against any portion of the inner bracket element 16b, the bracket elements 16 can be set in any dimension.

With continued reference to FIG. 5, in certain embodiments, the at least one position locking mechanism 22 may include a bendable retention tab 24 and vertical pilot holes 30. As shown in FIG. 4A. the bendable tab 24 may be located on a face of the vertical arm 20a of the outer bracket element 16a disposed between the walls 60 of the vertical arm 20a. The vertical pilot holes 30 may may be located on the walls 60 of the vertical arm 20a of the outer bracket element 16a. The bendable retention tab 24 is configured to bend inwards at an angle to provide holding power between the outer bracket element 16a and the inner bracket element 16b and allows for finer adjustment of the height of the bracket elements 16. The vertical pilot holes 30 allow for a screw 28 (e.g. self-tapping screws, pointed sheet metal screws, and/or the like) to be inserted to fasten the vertical arm 20a of the outer bracket element 16a to the vertical arm 20b of the inner bracket element 16b, thus, securing the height of the hanger frame 12. The screw 28 can be inserted in the vertical pilot holes 30, such that it presses against the nested inner bracket element 16b creating a friction fit or continuing through the bracket element 16 to create a continuous hole to mechanically secure the bracket elements 16 together. Because there is no matching part on the inner bracket element 16b, the bracket elements 16 can be fit in any dimension. Because the screw 28 can be pressed against any portion of the inner bracket element 16b, the bracket elements 16 can be set in any dimension.

With continued reference to FIG. 5, in certain embodiments, the at least one position locking mechanism 22 may include a hem 64 on the outer bracket element 16a such that when the hanger bracket elements 16 are nested, the hem 64 of the outer bracket element 16a wraps around the inner bracket element 16b, thus preventing the inner bracket element 16b from separating from the outer bracket element 16a. The hem 64 may be located on either or both of the vertical arm 20a or the horizontal arm 18a of the outer bracket element 16a.

With continued reference to FIG. 5, in certain embodiments, the at least one position locking mechanism 22 may include a plurality of corner pilot holes 68. The corner pilot holes 68 may be located on the walls 60 of the flaps 62 of the horizontal arm 18 of either the outer bracket element 16a or the inner bracket element 16b, such that when the flaps 62 are folded in, the corner pilot holes 68 overlap the walls 60 of its respective vertical arm 20. The corner pilot holes 68 are thus located at the corners of the hanger frame 12 when the inner bracket elements 16a and outer bracket elements 16b are in the nested configuration. The corner pilot holes 68 may be used in conjunction with screws 28 (e.g. self-tapping or pointed sheet metal screws) to secure the angle between the horizontal arms 18 and the vertical arms 20 of an individual bracket element 16.

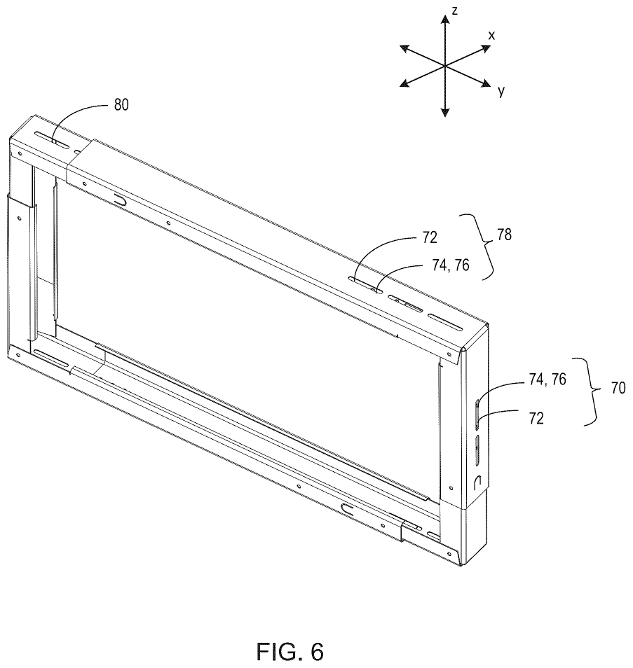

Referring now to FIG. 6, in certain embodiments, the vertical arms 20 of the bracket elements 16 may include a staggered vertical hole-slot assembly 70 to facilitate mounting the hanger frame 12 to a surface, such as a wall. The vertical arm 20a of the outer bracket element 16a may include a plurality of slots 72. The vertical arm 20b of the inner bracket element 16b may include a plurality of holes 74. A construction screw 76 (e.g. wood screw, drywall screw, and/or the like) may be driven through the vertical hole-slot assembly 70 from inside of the hanger frame 12 (i.e. from inner bracket side to outer bracket side) to secure the hanger frame 12 to the surface outside of the hanger frame 12. The holes 74 and slots 72 may be spaced in such a way to ensure that at least one hole 74 and at least one slot 72 may be used to secure the hanger frame 12 to the surface.

With continued reference to FIG. 6, in certain embodiments, the horizontal arms 18 of the bracket elements 16 may include a staggered horizontal hole-slot assembly 78 to facilitate mounting the hanger frame 12 to a surface, such as a ceiling. The horizontal arm 18a of the outer bracket element 16a may include a plurality of slots 72. The horizontal arm 18b of the outer bracket element 16b may include a plurality of holes 74. A construction screw 76 (e.g. wood screw, drywall screw, and/or the like) may be driven through the horizontal hole-slot assembly 78 from inside of the hanger frame 12 (i.e. from inner bracket side to outer bracket side) to secure the hanger frame 12 to the surface outside of the hanger frame 12. The holes 74 and slots 72 may be spaced in such a way to ensure that at least one hole 74 and at least one slot 72 may be used to secure the hanger frame 12 to the surface. In certain embodiments, the horizontal arm 18b of the inner bracket element 16b may include additional slots 80 that similarly allow for mounting of the hanger frame 12 to the surface.

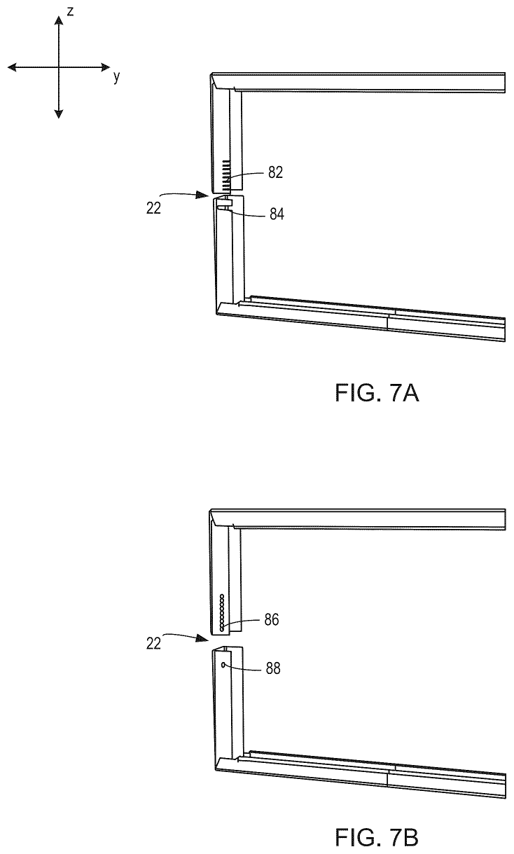

Referring now to FIGS. 7A-7B, shown are alternative embodiments of the at least one position locking mechanism 22. As shown in FIG. 7A, in certain embodiments, the at least one position locking mechanism 22 may include a plurality of bendable tabs 82 on the outer bracket element 16a and a notch 84 on the inner bracket element 16b. The plurality of bendable tabs 82 allow for the bracket elements 16 to be fixed at a plurality of different dimensions by bending one of the plurality of bendable tabs 82 such that it fits into the notch 84 of the inner bracket element 16b. For example, when the outer bracket element 16a receives its corresponding inner bracket element 16b, the inner bracket element 16b may be positioned within the outer bracket element 16a at the desired height and/or width. Once the desired height and/or width is achieved, the user may bend one of the plurality of bendable tabs 82 of the outer bracket element 16a into the notch 84 of the inner bracket element 16b. The bendable tab 82 engages with the notch 84 and locks the corresponding bracket elements 16 into the desired height and/or width.

As shown in FIG. 7B, in certain embodiments, the at least one position locking mechanism 22 may include a plurality of detents 86 on the outer bracket element 16a and a groove 88 on the inner bracket element 16a. The plurality of detents 86 allow for the bracket elements 16 to be fixed at a plurality of different dimensions. For example, when the outer bracket element 16a receives its corresponding inner bracket elements 16b, the inner bracket element 16b may be positioned within the outer bracket element 16a at the desired height and/or width. Once the desired height and/or width is achieved, one of the plurality of detents 86 may engage with the groove 88 and lock the corresponding bracket elements 16 into the desired height and/or width.

Referring again to FIGS. 1-2, in certain embodiments, the raceway system 10 includes at least two panels 32 configured to enclose a volume 34 defined by the at least two hanger frames 12. The panels 32 are connected to the hanger frames 12 by a panel attachment mechanism 36. The panels 32 may be of a number of non-exclusive materials including: drywall, fiberboard (e.g. light density, medium density, and/or the like), and drop ceiling tiles. The panels 32 not only functionally enclose the volume 34 and thereby the components 14, but they are also more conventionally aesthetically appealing than exposed components 14. The panels 32 may be, and typically are, painted before installation.

In further embodiments, a trim 38 covers an edge of a panel 32. The trim 38 can be made of Polymeric, metallic, or other materials. The trim 38 is designed to contain and hide the edges of the panels 32. The panels 32 have sharp or rough edges, so by covering them, the trim 38 protects occupants of the target building from scraps, cuts, and other hazards. The trim 38 may also serve an aesthetic purpose. In certain embodiments, the trim 38 is part of the structure holding the panels 32 to the hanger frames 12.

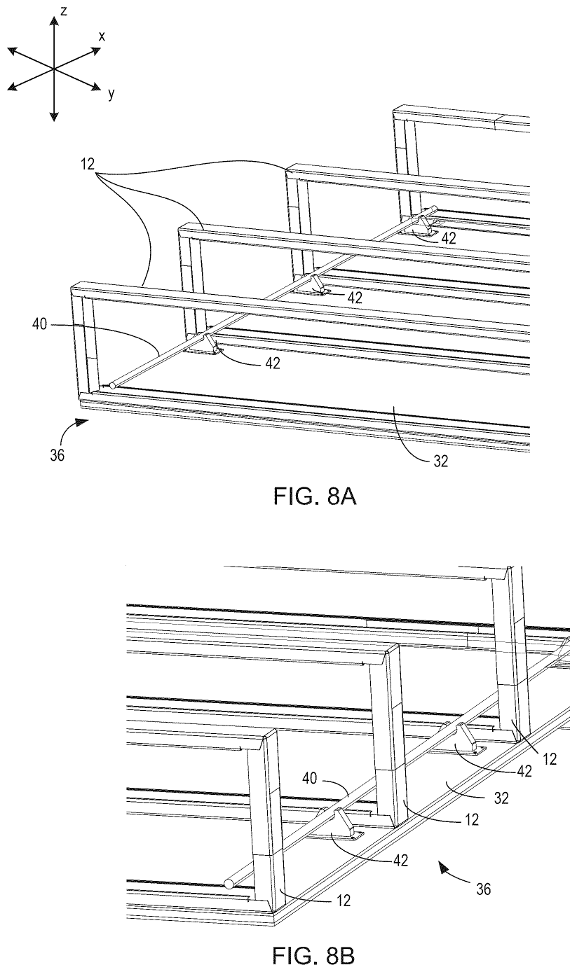

Referring now to FIGS. 8A-8B, in certain embodiments, the panel attachment mechanism 36 includes a rod 40 suspended within the hanger frames 12 and a complementary clip 42 fastened to a panel 32. The complementary clip 42 is mechanically fixed to the rod 40. This arrangement allows the complementary clips 42 to be pre-installed on the panels 32 with less X-axis precision.

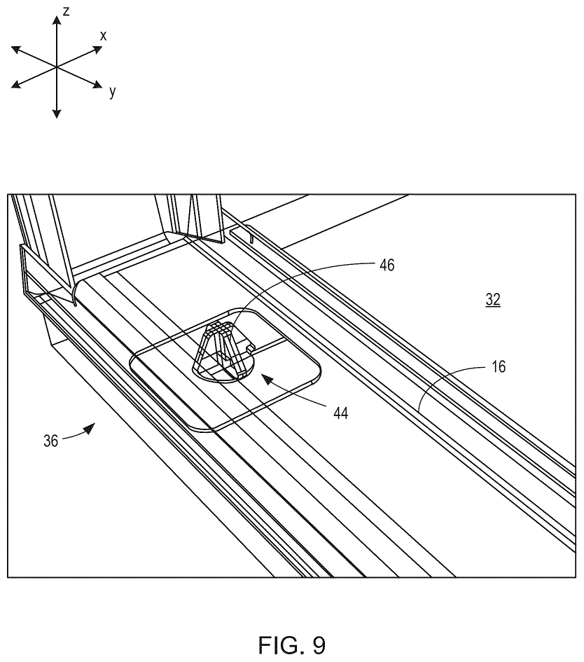

Referring now to FIG. 9, in certain embodiments, the panel attachment mechanism 36 includes a hole 44 in the bracket element 16 and a pyramid shaped clip 46 fixed to a panel 32. The pyramid shaped clip 46 is inserted in the hole 44 in the bracket element 16, such that the pyramid shaped clip 46 is non-releasably mated with the hole 44 in the bracket element 16. The shape of the pyramid shaped clip 46 assists in locating the pre-cut hole 44 and guiding the panel 32 insertion. This approach is suitable for situations when the pyramid shaped clip 46 can be precisely located on the panel 32 prior to attachment.

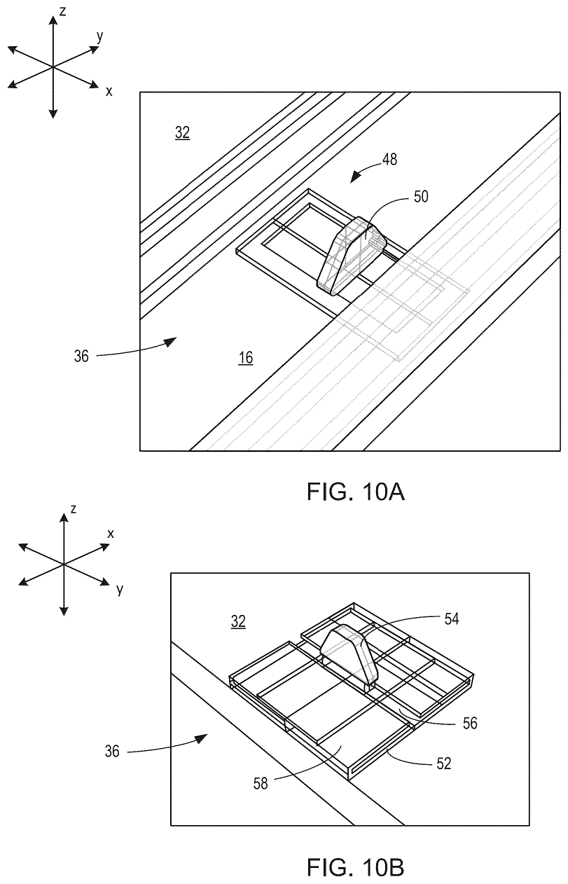

Referring now to FIGS. 10A-10B, in certain embodiments, the panel attachment mechanism 36 includes a slot 48 in the bracket elements 16 and a triangle shaped clip 50 fixed to a panel 32. The triangle shaped clip 50 is inserted in the slot 48 in the hanger bracket element 16, such that the triangle shaped clip 50 is non-releasably mated with the slot 48 in the bracket elements 16 while allowing for translation across one axis, here depicted in the X axis. This configuration allows for the panel attachment mechanism to be pre-installed with a larger tolerance in one direction.

In further embodiments, the triangle shaped clip 50 is fixed to the panel 32 via a translation mechanism 52. In these embodiments, the triangle shaped clip 50 includes a triangular body 54 and a base 56. The translation mechanism 52 is a compressed ‘c’ shaped bracket 58 attached to the panel 32 configured to receive the base 56 of the triangle shaped clip 50 allowing for translation across an additional axis, here depicted in the X and Y axes. This configuration allows for the panel attachment mechanism to be pre-installed with larger tolerances in two directions.

As shown in FIG. 2, in certain embodiments, at least one panel 32 has an opening for a ductwork boot 90. The ductwork boot 90 can be preinstalled or installed during installation of the raceway system 10.

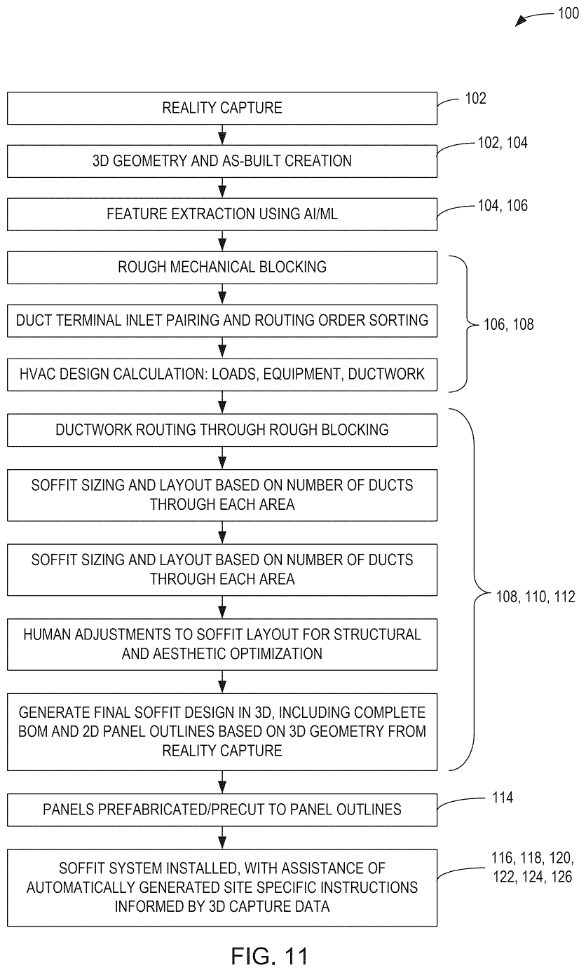

Now referring to FIG. 11, an exemplary method of using reality capture to design and prefab a layout for the raceway system 100. Certain embodiments of the method include capturing a scan of a target building in which the raceway system is to be installed 102, converting the scan to a 3D geometry 104, determining viable areas of the target building to locate a mechanical soffit 106, determining an optimal HVAC design 108, generating ductwork layout based on the viable areas 110, creating a set of fabrication instructions and shop drawings based on the optimal HVAC design 112, prefabricating panels to match the contours of the walls and ceiling based on the fabrication instructions and the shop drawings 114, assembling at least two hanger brackets elements to create at least two hanger frames of the desired dimension 116, and connecting the raceway system in the target building 118.

The capturing a scan of a target building in which the raceway system is to be installed 102 can be accomplished by a LIDAR scanner. Captured scan and corresponding data is from both the interior and exterior of the building, with a focus on indoor spaces that the soffit will be routed. The scan may then be converted to 3D geometry 104 using an algorithmic approach, such as a machine learning technique to classify the raw reality capture data (i.e., point clouds) as different geometric features (i.e., walls, ceilings, obstacles, etc.) and then fitting planes and surfaces to this classified data to generate a simplified 3D dimensional geometric model.

Determining an optimal HVAC design 108 will rely on considerations, such as load calculations, equipment selection, ductwork design, minimizing cost, accounting for aesthetic considerations, and other project considerations. For example, a ductwork layout may be generated 110 based on viable areas by first locating the duct terminals, central manifold and inlets, then pairing and sorting the duct terminals and inlets such that each duct can be routed without crossing over or otherwise colliding with another duct and then finding the optimal shortest route from each duct terminal to inlet within the viable routing geometry, creating a simplified raceway design based on the minimum required dimensions to contain the ducts in any given area. Then a set of fabrication instructions and shop drawings may be created 112 based on the schematic raceway design.

In further embodiments, connecting the raceway system to the target building 118 include installing the at least two hanger frames in the target building 120, fitting components through the at least two hanger frames 122, attaching at least one panel to the at least two hanger frames 124, and joining at least one trim to each panel 126.

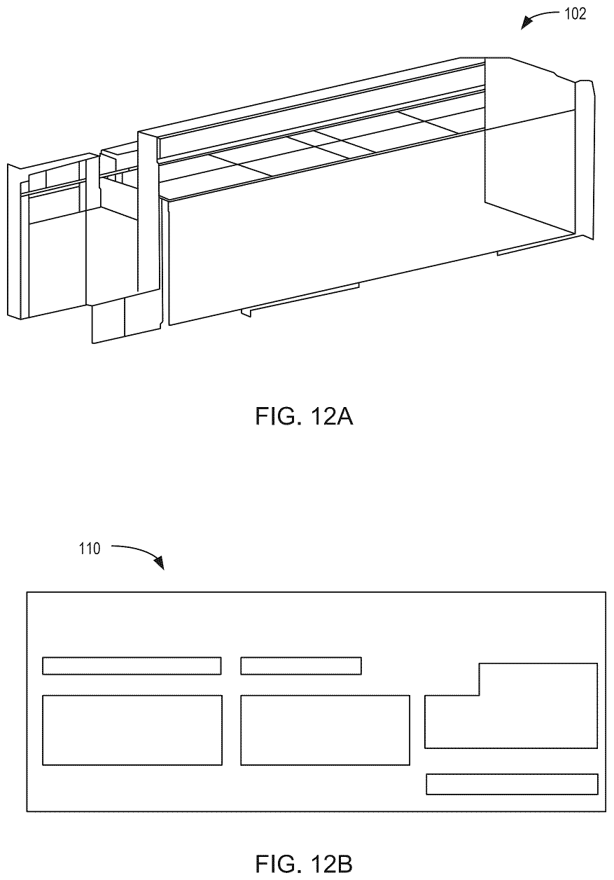

Referring now to FIGS. 12A-12B, shown is an exemplary step of capturing a scan of a target building in which the raceway system is to be installed 102 (FIG. 12A), converting the scan to a 3D geometry 104, determining viable areas of the target building to locate a mechanical soffit 106, determining an optimal HVAC design 108, generating ductwork layout based on the viable areas 110 (FIG. 12B), and creating a set of fabrication instructions and shop drawings based on the optimal HVAC design 112.

It will be appreciated by persons skilled in the art that the present disclosure is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the disclosure. A variety of modifications and variations are possible in light of the above teachings without departing from the scope and spirit of the disclosure, which is limited only by the following claims.

What is claimed is:

1. A raceway system, comprising:
at least two hanger frames configured to support at least one component, the at least two hanger frames comprising at least two hanger bracket elements,
the at least two hanger brackets elements including at least one outer bracket element and at least one inner bracket element, and at least one position locking mechanism for mechanically securing the at least two hanger bracket elements in a position, and
wherein the at least one inner bracket element is configured to nest within the at least one outer bracket element and the two hanger bracket elements are connected by the position locking mechanism at a predetermined distance.

2. The raceway system of claim 1, wherein the at least two hanger frames is four hanger brackets elements.

3. The raceway system of claim 1, wherein the at least one position locking mechanism comprises:
multiple bendable tabs on the outer bracket element, and a notch on the inner bracket element, and
wherein a bendable tab of the outer bracket element is bent such that it is fit into the notch of the inner bracket element.

4. The raceway system of claim 1, wherein the at least one position locking mechanism comprises:
multiple detents on the inner bracket element, and a groove on the outer bracket element, and
wherein a detent of inner bracket element is fixedly connected with the groove of the outer bracket element.

5. The raceway system of claim 1, wherein the at least one position locking mechanism comprises:
a bendable table on the outer bracket element, and
wherein the bendable tab is bent inward such that it presses against the nested inner bracket element creating a friction fit.

6. The raceway system of claim 1, wherein the at least one position locking mechanism comprises:
a screw pilot hole on the outer bracket element, and a screw,
wherein the screw is inserted in the screw pilot hole such that it presses against the nested inner bracket element creating a mechanical or friction fit.

7. The raceway system of claim 1, wherein the at least one position locking mechanism comprises:
at least one hem on the outer bracket element,
wherein when nested, the hem wraps around the inner bracket element locking the bracket elements in a position; and
a screw,
wherein the screw is inserted in a screw pilot hole on the outer bracket element such that it presses against the nested inner bracket element creating a friction fit.

8. The raceway system of claim 1, wherein each of the at least one outer bracket elements include a horizontal arm and a vertical arm, and
each of the at least one inner bracket elements include a horizontal arm and a vertical arm,
wherein the horizontal arm of one of the at least one outer bracket elements is configured to receive the horizontal arm of one of the at least one inner bracket elements, and
the vertical arm of one of the at least one outer bracket elements is configured to receive the vertical arm of one of the at least one inner bracket elements.

9. The raceway system of claim 8, wherein the vertical arm of at least one outer bracket element includes a plurality of slots, and
the vertical arm of at least one inner bracket element includes a plurality of holes,
wherein at least one of the plurality of holes is positioned to align with at least one of the plurality of slots when the vertical arm of the inner bracket element is nested within the vertical arm of the outer bracket element, and
wherein a screw is configured to extend through the aligned hole and slot from the inner bracket element toward the outer bracket element to secure the hanger frame to a surface.

10. The raceway system of claim 8, wherein the horizontal arm of at least one outer bracket element includes a plurality of slots, and
the horizontal arm of at least one inner bracket element includes a plurality of holes,
wherein at least one of the plurality of holes is positioned to align with at least one of the plurality of slots when the horizontal arm of the inner bracket element is nested within the horizontal arm of the outer bracket element, and
wherein a screw is configured to extend through the aligned hole and slot from the inner bracket element toward the outer bracket element to secure the hanger frame to a surface.

11. The raceway system of claim 10, wherein the horizontal arm of at least one inner bracket elements includes the plurality of slots at an end opposite the plurality of holes,
wherein the screw is configured to extend through at least one of the slots to secure the hanger frame to a surface.

12. The raceway system of claim 1, further comprising:
at least two panels configured to enclose a volume defined by the at least two hanger frames,
wherein the at least two panels are connected to the at least two hanger frames by a panel attachment mechanism.

13. The raceway system of claim 12, further comprising:
at least one trim element configured to cover an edge of the at least two panels.

14. The raceway system of claim 12, wherein the panel attachment mechanism includes:
a rod suspended within the at least two hanger frames, and a complementary clip fastened to a panel,
wherein the complementary clip is mechanically fixed to the rod.

15. The raceway system of claim 12, wherein the panel attachment mechanism includes:
a hole in a bracket element, and
a pyramid shaped clip fixed to a panel,
wherein the pyramid shaped clip is inserted in the hole in the bracket element such
that the pyramid shaped clip is self-guided and non-releasably mated with the hole in the bracket element.

16. The raceway system of claim 12, wherein the panel attachment mechanism includes:
a slot in a hanger bracket element, and
a triangle shaped clip fixed to a panel,
wherein the triangle shaped clip is inserted in the slot in the bracket element such
that the triangle shaped clip is non-releasably mated with the hole in the bracket element while allowing for translation across one axis.

17. The raceway system of claim 16, wherein the triangle shaped clip is fixed to the panel via a translation mechanism,
wherein the triangle shaped clip comprises:
a triangular body, and a base, and
wherein the translation mechanism is a compressed ‘c’ shaped bracket attached to the panel configured to receive the base of the triangle shaped clip allowing for translation across an additional axis.

18. The raceway system of claim 12 wherein,
at least one panel has an opening for a ductwork boot.

19. A method of using reality capture to design and prefab a layout for the raceway system of claim 1 comprising:
capturing a digital scan of a target building in which the raceway system is to be installed, converting the scan to a simplified 3D geometry,
determining viable areas of the target building to locate a mechanical soffit, determining an optimal HVAC design,
generating ductwork layout based on the viable areas,
creating a set of fabrication instructions and shop drawings based on the optimal HVAC design,
prefabricating panels based on the fabrication instructions and the shop drawings, assembling at least two hanger bracket elements to create at least two hanger frames of the
desired dimension, and
connecting the raceway system in the target building.

20. The method of claim 19 wherein, connecting the raceway system in the target building comprises:
installing the at least two hanger frames in the target building, fitting components through the at least two hanger frames, attaching at least one panel to the at least two hanger frames, and joining at least one trim to each panel.
